(19) United States
(12) Patent Application Publication
(10) Pub. No.: US 2013/0317135 A1
(43) Pub. Date: Nov. 28, 2013

(54) WATER SHUT-OFF SYSTEM FOR PRODUCTION AND/OR INJECTION WELLS

(71) Applicant: Isabel Natalia VEGA, Provincia of Neuquen (AR)

(72) Inventor: Isabel Natalia VEGA, Provincia of Neuquen (AR)

(73) Assignee: Servicios Especiales San Antonio S.A.

(21) Appl. No.: 13/480,891

(22) Filed: May 25, 2012

(51) Int. Cl. C09K 8/42

(52) U.S. Cl. 523/130

(57) ABSTRACT

Water Shut-off (WSO) system comprising organic products with relatively low viscosity, which are pumped to into a well in liquid state, and after a certain period of time, reach the desired consistence that may vary from a rigid gel, to produce a complete water flow blockage, up to deformable gels, which produce only a partial blockage effect, reducing significantly the water passage and still allowing the oil passage.

### BACKGROUND OF THE INVENTION

1. Field of the Invention

The present invention relates to a novel well treatment system suitable for application on gas and/or oil wells and, more particularly refers to a novel chemical composition for Water Shut-off (WSO) which permits the controlled blockage of very permeable formation areas, reducing the production and redirecting the injection water flow into the reservoirs, with system or composition being versatile and capable of generating sealing or non-sealing gels, depending on the particular composition, to control blockage on the water flow.

2. Description of the Prior Art

Ii is well known in the art and the oil industry the “secondary recovery” techniques which have been applied increasingly to improve hydrocarbon production. These techniques consist in the injection of chemically treated water through wells conditioned for this purpose, in order to sweep the residual oil retained in the formation. Since the injected water generally presents lower viscosity than the crude oil, and due to the innate reservoir heterogeneity, after a certain period of time, water channels through highly permeable zones limit the treatment efficiency. This leads to high costs associated to production water treatment, handling and disposal which make the secondary recovery unprofitable.

Taking these limitations into account, several techniques have been developed to redirection the injected water flow into the reservoir in order to treat the formations that have not been adequately swept. Most of the proposed systems consist in pumping organic products into the well, either in injection or production wells, in liquid state and, after a certain period of time, e.g. hours or days, a rigid gel is generated which creates a permanent partial or complete seal in the most permeable layers of the treated formations. Thus, it is possible to redirect the injection water to the reservoir zones containing hydrocarbon reserves. These blocking treatments, prepared in batch, are commonly known as “Water Shut-off” (WSO).

The aim of this technique is the reduction of water production and costs associated to water-oil separation process. Moreover, the reduction of equipment costs as well as the costs of corrosion, scale formation and sand production is also sought. On the other hand, WSO also allows reducing the formation water extraction and re-injection costs, minimizing the environmental impact.

Water Shut-Off treatments increase hydrocarbon production, by enlarging the reservoir sweeping area under secondary recovery. Therefore, it increases the reservoir life time optimizing oil recovery.

The WSO technology is applied not only in wells under secondary recovery but also in production wells with high natural brines cuts coming from aqueous zones.

Nowadays, there are many methods in use to control water production. One of the first methods used in the oil and gas industry consisted in the application of sand, cement or calcium carbonate plugs. Afterwards, new tools were developed for providing mechanical isolations or blockings, e.g. packers and casing-patch. Recently, new chemical systems were also performed such as the injection of gels, resins, foamed fluids, emulsions and particulates, among others.

Three different techniques can be listed, among the chemical methods used for optimizing oil recovery, i.e. Enhanced Oil Recovery (EOR) or for water production control:

Polymers for Water Flooding.

Polymeric systems for increasing water viscosity are used to enhance the water to oil mobility ratio, optimizing the oil sweep during water injection, i.e. water flooding. These systems are commonly pumped through the injector wells.

Relative Permeability Modifiers (RPM).

These products are treatments based on hydrophilic polymers that are pumped into the formations reducing water permeability without affecting significantly oil permeability. Although this kind of treatment is directly applied to production wells, systems based on RPM have been proposed for treating injector wells. The systems based on RPM present, in general, low viscosity and do not generate a significant formation pore space blockage.

Permeability Blocking Systems for Water Shut-Off.

Systems designed for partial or total formation blockage, used for sealing highly permeable formation channels where water is produced. These treatments are designed for both, production and injection wells. A low viscosity polymer solution is pumped into the formation and once placed in the zone to be treated, becomes a rigid gel increasing its viscosity drastically. This creates a blockage effect in the most permeable layers where the water is being produced.

A permanent blocking system for Water Shut-Off (WSO) is disclosed in US 2004/0177957, to Kalfayan et al. wherein the disclosed system is related to Relative Permeability Modifiers. Kalfayan et al. discloses PAM/HPAM formulations with aminosilanes which, through simple lab tests conducted with extremes PAM/HPAM Mw and concentrations as well as extreme concentrations of silane, as disclosed by Kalfayan et al., showed that while keeping initial workable viscosity of maximum 40 Cp at 300 rpm none could reach the desired gels strength for WSO blocking effect. To better explain these results, FIG. 1 shows that Kalfayan systems did not reach enough final viscosities to act as blocking agents, even if titanate is added. On the other hand, the extreme polymer concentration systems (8% PAM Mw 200 KDa) showed final viscosities suitable for blockage but due to initial viscosities superior to 100 Cp, made them unsuitable for this kind of treatments.

### SUMMARY OF THE INVENTION

It is therefore an object of the invention to provide a novel chemical system for Water Shut-off which permits the blockage of very permeable formation areas, reducing the production and redirecting the injection water flow into the reservoirs.

It is still another object of the present invention to provide a novel treatment consisting in organic products with relatively low viscosity, which are pumped to the well, either injector or production wells, in liquid state, and after a certain period of time, such as hours or days, reach the desired consistence according to each treatment needs.

It is another object of the present invention to provide a novel treatment that may vary from a rigid gel, used as sealants which produce the complete water flow blockage, up to deformable gels, which produce only a partial blockage effect, reducing significantly the water passage and still allowing the oil passage, wherein the treatments may be prepared in batches and are of the type called Water Shut-off (WSO).

It is a further object of the present invention to provide a water shut-off system for producing at least a partial blockage in the water production of production and/or injection wells, the system comprising an aqueous composition including:

a) at least one polyacrylamide (PAM);

b) at least one crosslinker comprising an alkoxysilane compound, and

c) at least one modifier comprising an organotitanate.

It is a further object of the present invention to provide a WSO system for partial or total water production blockage, applied in production or injection wells, wherein the WSO system is an aqueous composition comprising a mixture of:

between about 0.3% w/v and about 4% w/v of a polyacrylamide or partially hydrolyzed polyacrylamide of 2 MDa<M_{w}<20MDa;

between about 0.03% w/v to about 3% w/v of an alkoxysilane compound with two or more amine groups attached to a R substituent, used as crosslinker, and

between about 0.05% w/v to about 5% w/v of an organotitanate used as a modifier, and optionally:
thiourea between about 0% w/v to about 0.2% w/v; KCl between about 0% w/v and about 2% w/v, and water between about 86% w/v and about 99.7% w/v.

It is a further object of the present invention to provide a method for preparing the Water Shut-off system of the invention, comprising the steps of:

Preparing a KCl brine;

Adding, under high agitation, the polymer to the brine previously prepared;

Agitating for approximately 2 hours or up to obtaining a constant viscosity and transparent appearance, with polyacrylamide granules totally hydrated,

Adding the titanate and following the crosslinker, and

Agitating until obtaining a total dispersion.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 shows graph illustrating the viscosity performance vs. time of three formulations containing different silane percentages.

FIG. 2 shows a possible mechanism between the polyacrylamide and the crosslinker according to the present invention.

FIG. 3 shows graph comparing a system without modifier and a system containing 1% of a modifier.

FIG. 4 shows the most probable reaction mechanism between polyacrylamide, crosslinker and modifier, according to the invention.

FIG. 5 shows a reaction, according to the invention, with formation of esters and tridimensional network generation composed by polymer and titanate.

FIGS. 6-10 show graphs illustrating the initial gel time variation (Tgi) of the inventive systems at 45 and 65° C. evaluated at a shear rate speed of 30 s⁻¹.

FIG. 11 shows the pumping sequence used in the test of the invention with Berea Sandstone.

FIG. 12 shows the variation of RRF to oil and water as a function of pressure gradient applied, expressed in psi/ft, during the evaluation of the polymer bonding.

### DESCRIPTION OF THE PREFERRED EMBODIMENTS

Now referring in detail to the invention, the same discloses a water shut-off system comprising the use of an aqueous solution of medium to high molecular weight, preferably a non-hydrolyzed and/or partially hydrolyzed polyacrylamide, a crosslinker, preferably of the organosilanes family, which contains two or more amino groups placed in the same Rₙ silane substituent, and a modifier. The modifier is present in variable concentrations to increase reaction rates and the final consistency of the formed gel, depending on the treatments needs for each specific well and formation under intervention. Such modifiers may be chelate organotitanates and/or tetraalkyltitanates.

The water shut-off system or composition of the invention preferably comprises a versatile water shut-off system which can generate sealant or non sealant gels to be applied either on production or on injection wells as treatments for controlling water production. The versatility of the system is based on the possibility of forming gels of different consistencies upon variation of the concentrations of at least one polymer, such as polyacrylamide, at least one crosslinker, such as organosilanes, and at least one modifier, such as organotitanates, as well as upon variation of the molecular weight and hydrolysis degree of the polymer, e.g. the polyacrylamide.

According to the invention, tridimensional networks are formed from the reaction between the polyacrylamide at concentrations comprised between 0.3 to 4% in the aqueous solution, the crosslinker, between 0.03% to 3% v/v, and the modifier, between 0.05 to 5% v/v. The initial polymeric solution viscosity is quite low, not exceeding 40 cp @ 300 rpm. This condition is essential to avoid high injection pressures that could fracture the treated formation.

Hydrolyzed organotitanates are used as crosslinking agents of a wide variety of polymers such as silicone. As a result, the structure of the final gel is quite stiff comparing with the same structure in absence of titanate. The organotitanate compound may be an acetylacetonate titanate chelate, lactic acid titanate chelate ammonium salt, triethanolamine titanate chelate or a mixture of chelates with at least one component that contains the following structure:

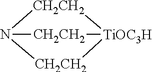

Among the possible alkoxysilanes assayed as crosslinkers, the most suitable is the one that contains two or more amino groups in its structure, of general formula RₙSiX₄₋ₙ, where R is alkyl or aryl, non-hydrolyzable groups, functionalized with two or more amino groups placed in the same Rₙ substituent. Such groups are those that, by chemical compatibility, interact with the polyacrylamide. Alkoxy groups are represented by X, and can be methoxy or ethoxy, which can be hydrolyzed by liberating alcohols to the medium to form silanoles. The silanoles can react with the modifier enhancing the WSO system properties.

The organosilicon compound is preferably an N-(βaminoR)-γ-aminoR₂trialkoxysilane, wherein R can be alkyl or aryl groups and OX are the alkoxy groups:

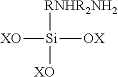

According to the invention, silanes are employed to obtain a strong interaction thereof with silicates and other minerals present in the reservoir rock. This effect has been extensively used in the oil and gas industry for fine migration control. This same effect increases the WSO system bonding to the reservoir rock which tightly attaches the WSO gel to the formation, avoiding sweeping processes.

More particularly, the system of the invention comprises a linear polymeric aqueous solution, of non-hydrolyzed polyacrylamide (PAM) to partially hydrolyzed polyacrylamide (HPAM), with molecular weight values between 0.1 to 50 MDa, a crosslinker from the alkoxysilanes family containing two or more amino groups in its structure. These systems may contain modifiers or synergists capable of speeding up the gel generation as well as its final consistency. The synergists mentioned above are organic chelate titanates, as well as the tetraalkyltitanates. For temperatures higher than 65° C., thiourea should be added in order to maintain the polymer stability.

The system of the invention is preferably a composition comprising:

0.3 to 4% w/v PAM or HPAM (0.1<Mw<50 MDa);

0.03 to 3% v/v crosslinker;

0.05 to 5% v/v modifier, and optionally

0 to 2% w/v KCl;

0 to 0.2% w/v thiourea, and

86 to 99.7% Water.

Preferably, the crosslinker is a reactive silane and the modifier is titanate.

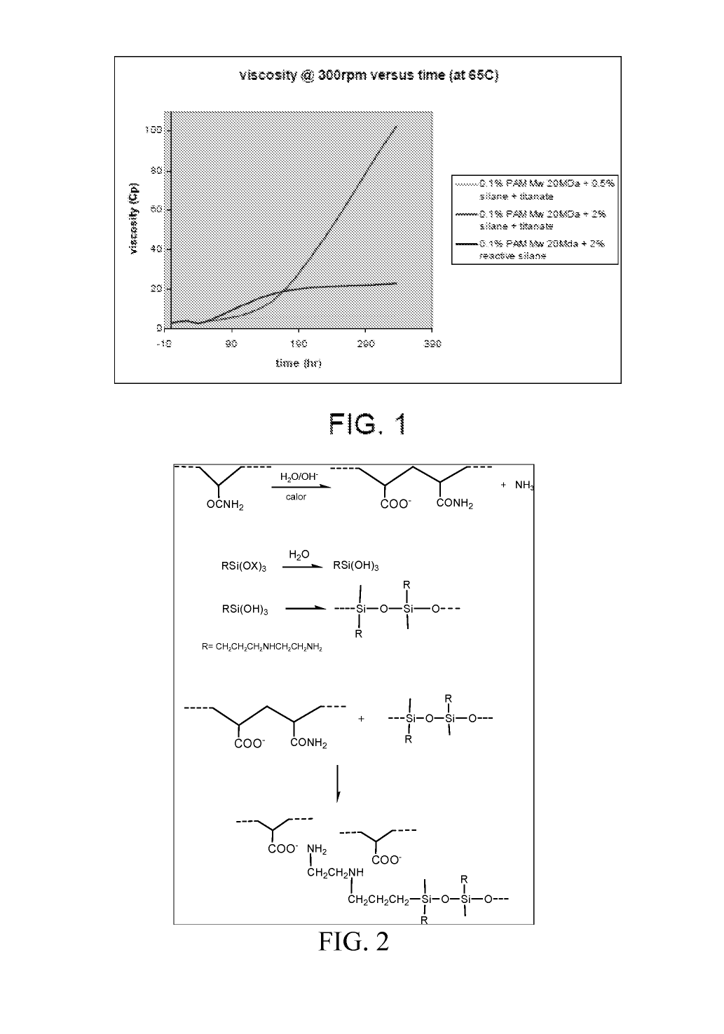

The present invention is preferably focused on the system or preparations with the sole intent to block the most permeable formation layers, that is, is focused in a permanent blocking system for Water Shut-Off (WSO). This differs from the prior art, such as Kalfayan et al. (US2004/0177957) disclosing a system related to Relative Permeability Modifiers. While both, the present invention and Kalfayan et al. disclose PAM/HPAM formulations with aminosilanes, as indicated above, formulations with extreme PAM/HPAM Mw and concentrations as well as extreme concentrations of silane, as disclosed by Kalfayan et al., while keeping initial workable viscosity of maximum 40 Cp at 300 rpm, they could not reach the desired gels strength for WSO blocking effect. FIG. 1 shows the performance of Kalfayan's systems which did not reach enough final viscosities to act as blocking agents, even with the addition of titanate. On the other hand, the extreme polymer concentration systems (i.e. 8% PAM Mw 200 KDa) showed final viscosities suitable for blockage but, due to initial viscosities superior to 100 Cp, made them unsuitable for this kind of treatments.

The gelation process, according to the invention, is believed to be carried out in four associated steps. The first one encompasses the hydrolysis of alkoxy groups (X) of the silane. Right after hydrolysis, the just formed silanoles condensate each other with water elimination. However, when heated in basic medium, which is created by the presence of the silanes, polyacrylamide is partially hydrolyzed and the formed carboxylates interact with silane amine groups possibly through hydrogen bonds or amide formation. A possible mechanism between polyacrylamide and crosslinker is illustrated in FIG. 2.

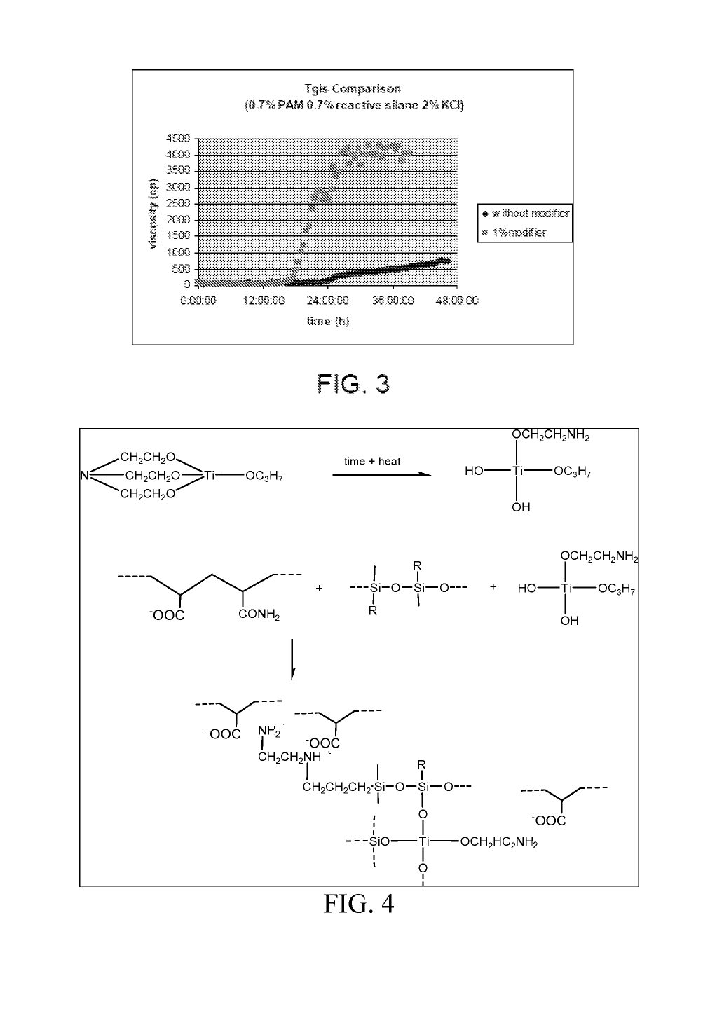

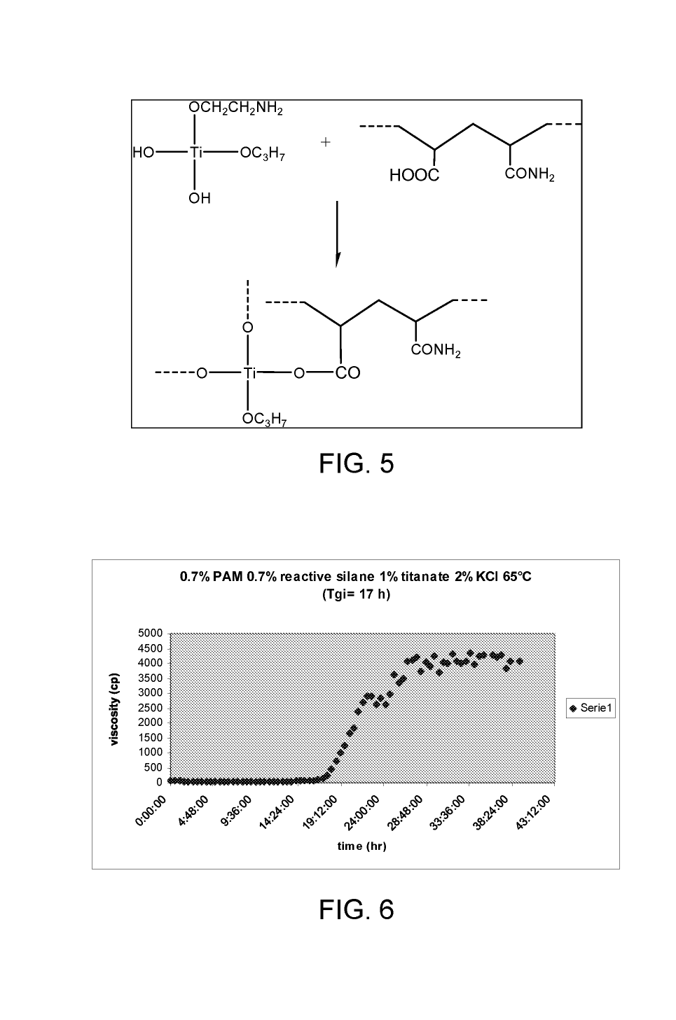

It is possible to verify that gelation time diminishes in presence of titanates and the consistency is drastically increased. The gels obtained in this way are much stronger with higher viscosity values than those obtained by formulations without titanates. A system containing 1% of a modifier and a system without modifier are compared in the graph of FIG. 3.

According to the invention, the most probable reaction mechanism between polyacrylamide, crosslinker and modifier (chelate titanate) is shown in FIG. 4. In basic medium, the titanates hydrolysis is much slower than in acid medium. The alkoxytitanate formed upon hydrolysis is very reactive; combining rapidly with silanes, but their amine groups continues interacting electrostatically with polyacrylamide carboxylate groups as above.

In acid medium, in presence of silane and polyacrylamide, there is no gel formation, which justifies the idea that the interaction between polymer and silane is done through the amine groups from the silane and the carboxylates. Those groups in acid medium are protonated, which prevent them from interaction. However, if titanate is added to such acid medium, it rapidly hydrolizes and the hydroxyl groups formed interact with carboxylic groups from polyacrylamide, with the formation of esters and tridimensional network generation composed by polymer and titanate, see FIG. 12. This reaction is almost instantaneous.

When the polyacrylamide, silane and titanate system is conditioned to pH=7 and submitted to 65° C. temperature, no gel formation is observed during the testing period (1 week).

An additional advantage of this system is the capacity to revert its blocking action within the first 15 days of being prepared if the gel is treated with a 0.06% w/v solution of a strong oxidant as ammonium persulfate or sodium hypochlorite. Once the WSO gel has fortnight, the treatment cannot be attacked by oxidants or extreme pH.

The system of the invention, without acid or base addition, has demonstrated to have the same or better properties than sealant or no sealant water shut-off gels already existent. Depending on the formulations, non-fluid, highly deformable gels can be obtained, grade A, according to the below code list, up to rigid ones, grade F, according to the below code list. Gelation time can vary from a few hours to more than 2 days, depending on the concentration and type of polymer, crosslinker, modifier concentrations and temperature. Other advantage of this system is that at room temperature, gelation time is very large, from 1 to 2 weeks. This difference in reaction rate with temperature allows the system to be very much versatile during mixing and pumping procedures, as the risk of undesired premature gelling is eliminated.

This system is suitable for high temperatures (>80° C.) due to its gelling time can be manage by modification of polymer and crosslinker proportions. Thus, Tgi may vary from hours up to days according to the necessities of each case.

The following list presents the consistency classification grades used for WSO gels:

Code List:

A: barely fluid gel. The gel flows slowly to the bottle cap. A significant
portion of the gel does not flow upon inversion.
B: Highly deformable non flowing gel. The gel does not flow upon
inversion.
C: Moderately deformable nonflowing gel.
D: Slightly deformable nonflowing gel. Only the surface is deformed
upon inversion.
E: Rigid gel. The surface does not deform upon inversion.
F: Ringing rigid gel. A mechanical vibration, similar to a tuning fork, can
be felt after the bottle is tapped.
G: Fluid gel.
H: Viscous liquid.

The WSO system of the present invention suits to a wide range of service conditions, i.e. formations composition and petrophysics, temperature, pressure, etc., found in the reservoirs. Among the additional advantages of this system, the following can be mentioned:

1. The presence of salt in water does not destabilize the formed gel;

2. At high temperatures the crosslinking time can be adjusted according to the formation requirements, and

3. The gel can be removed using strong aqueous oxidant solutions.

The invention may be better understood with reference to the following examples which are not limitative or restrictive of the scope of protection. On the contrary, it must be clearly understood that many other embodiments, modifications and alterations equivalent to the elements of the invention may be suggested by persons skilled in the art after reading the present description, without departing from the spirit of the present invention and/or the scope of the appended claims.

Also according to the invention, a method for preparing the Water Shut-off system is proposed, wherein the method comprises the steps of:

Preparing a KCl brine according to the treatment volume to be pumped;

Adding, under high agitation, the polymer to the brine previously prepared;

Agitating for approximately 2 hours or up to obtaining a constant viscosity and transparent appearance, preferably, polyacrylamide granules should be totally hydrated, and

Adding the titanate and following the crosslinker (reactive silane) at the desired amounts, and

Agitating until obtaining a total dispersion.

The following inventive systems and Tests have been prepared and carried out.

Rheological Behavior WSO

The behavior of the systems varying polymer concentration, as well as crosslinker and modifier concentrations, has been rheologically evaluated. It could be observed that the gel strength consistency changed as a function of time, temperature and components concentrations. The graphs of FIGS. 6-10, are examples of applications of the present invention showing the influence of crosslinker and modifier concentration in the initial aqueous solutions. The measurements were performed using a viscometer type OFITE 900 at temperatures from 25 to 65° C.

The graphs show the initial gel time variation (Tgi) at 45 and 65° C. evaluated at a shear rate speed of 30 s⁻¹. The approximated PAM molecular weight is 8 MDa.

### Example 1

viscosity graph versus time @ 65° C. (FIG. 6).

0.7% PAM

0.7% reactive silane

1% titanate

2% KCl

### Example 2

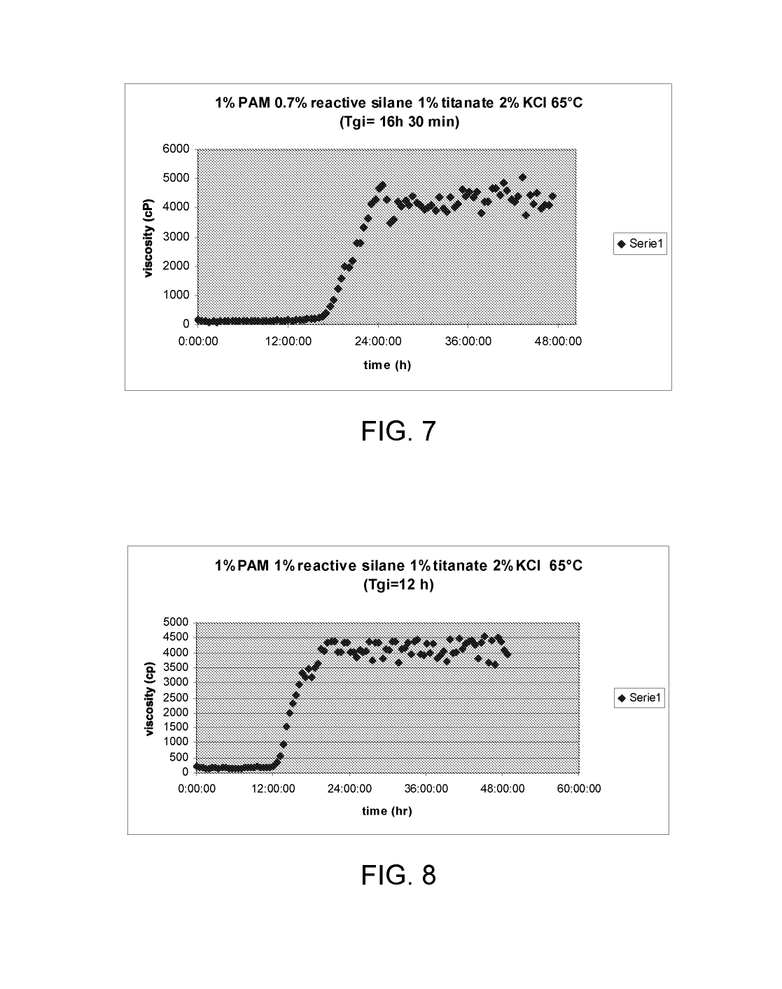

viscosity graph versus time @ 65° C. (FIG. 7).

1% PAM

0.7% reactive silane

1% titanate

2% KCl

### Example 3

viscosity graph versus time @ 65° C. (FIG. 8).

1% PAM

1% reactive silane

1% titanate

2% KCl

### Example 4

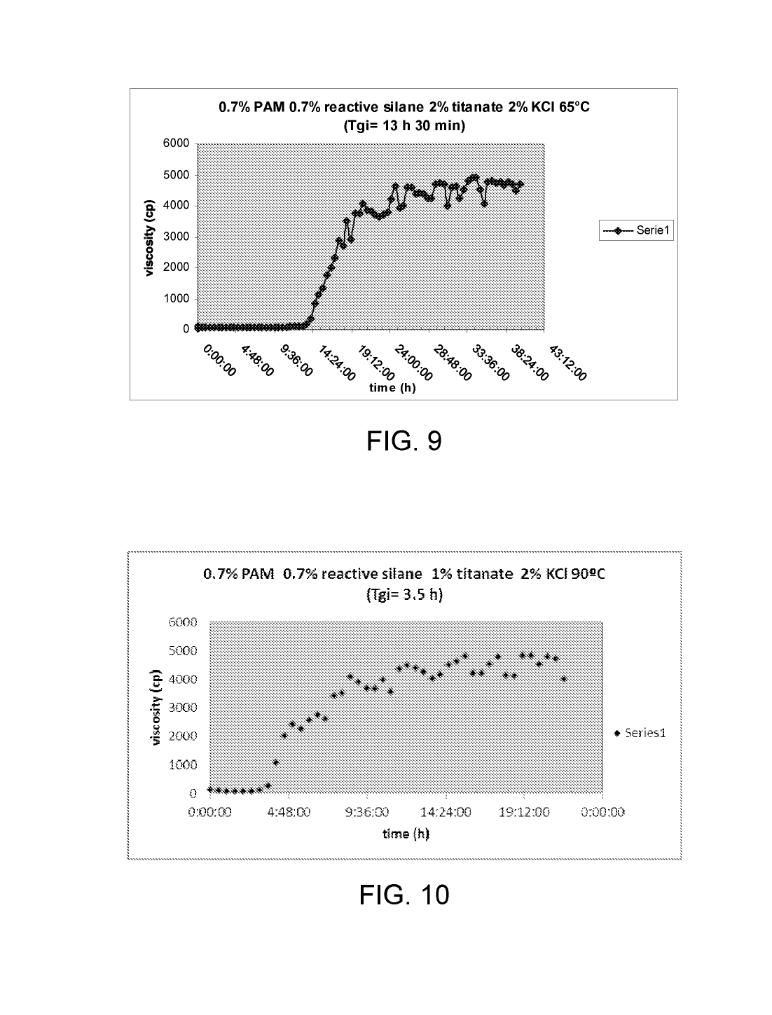

viscosity graph versus time @ 65° C. (FIG. 9).

0.7% PAM

0.7% reactive silane

2% titanate

2% KCl

### Example 5

viscosity graph versus time @ 90° C. (FIG. 10).

0.7% PAM

0.7% reactive silane

1% titanate

2% KCl

The results from examples cited above show that the gel time depends on the polymer, crosslinker and modifier concentrations, as well as the temperature to which the system is submitted.

Sealant Behavior WSO

This section presents laboratory tests performed according to the selected WSO formulations of the present invention, demonstrating the sealant and partially sealant action of the system.

Evaluation Methodology

The WSO treatment efficiency was evaluated by means of flow tests performed on formation sandstone and Berea sandstone core plugs of known permeability.

The core plugs have 3.8 cm of diameter and 7 cm long. The assays are performed simulating the following reservoir conditions, 65° C. and 1500 psi of confinement pressure.

Table 1 shows the properties of the core plugs used in the flow assays.

TABLE 1

| | | Permeability | Grain density |
|---|---|---|---|
| Test core | Porosity (%) | (mD) | (g/cm³) |
| Sandstone | 18.1 | 455 | 2.66 |
| Berea | 13.9 | 87 | 2.64 |

The aqueous system used was filtered 2-API brine (5 weight % NaCl+2 weight % KCl+1 weight % CaCl₂). The hydrocarbon system used was gasoil. Both fluid systems were injected in the production direction. The water saturated core plug was assembled into the testing cell of a formation response tester (FRT) Chandler 9000, and it was conditioned at temperature and confinement pressure.

For each case, the flow and the differential pressures were measured on both core plug faces. Each fluid was pumped at different flow rates, beginning with the lowest possible value (in some cases down to 0.01 ml/min). Once stability was reached, the flow was gradually increased upon pumping pressure limitations.

Once the core plug was assembled in the equipment, the production and injection flow directions were defined. Pumped fluids are:

1. Hydrocarbon before WSO treatment (K_{Opre}). Hydrocarbon permeability at saturation of irreducible water (K_{Owi}), was used as reference for hydrocarbon permeability comparison after polymer injection.

2. Brine before WSO treatment (K_{Wpre}). Water (2-API) permeability at saturation of residual hydrocarbon (K_{Wor}) was used as reference for water permeability comparison after polymer injection.

3. WSO polymer injection at 0.5 ml/min in the injection direction. Typical volume injected was 5 PV (pore volumes). Afterwards it was laid in rest for 24 hours.

3. Hydrocarbon was pumped again at three flow rates (similar to the initial). Based on differential pressure values measured at each flow rate, the post-treatment hydrocarbon average permeability (K_{Opos}) was determined.

5. Finally, the brine 2-API was pumped at the production direction at three different flow rates for obtaining the post-treatment water average permeability (K_{Wpos}).

The permeability residual resistance factor (RRF) to water or oil was determined as follows:

$$RRF = \frac{\frac{{K}_{pre}}{{μ}_{pre}}}{\frac{{K}_{pos}}{{μ}_{pos}}}$$

Where: Kₚᵣₑ and Kₚₒₛ are hydrocarbon or water permeability, measured pre- or post-WSO treatment. μₚᵣₑ, μₚₒₛ, are viscosities, e.g. of gasoil or water, pre- and post-treatment. In the present assays, μₚᵣₑ=μₚₒₛ. Based on the flow tests, RRF_{W} y RRF_{O} are determined.

Results.

The flow tests results performed on the formation sandstone and Berea sandstone core plugs treated with the WSO system are as follows:

Test with Berea Sandstone.

Taking into account that the Berea sandstone core plug test shows lower permeability and porosity comparing to the formation core plug, a partially blocking WSO system (0.7% PAM+0.7% reactive silane+1% titanate+2% KCl) was used. This system assures a suitable matricial penetration of the treatment into the rock, as well as a strong bonding to it, even at high flow rates.

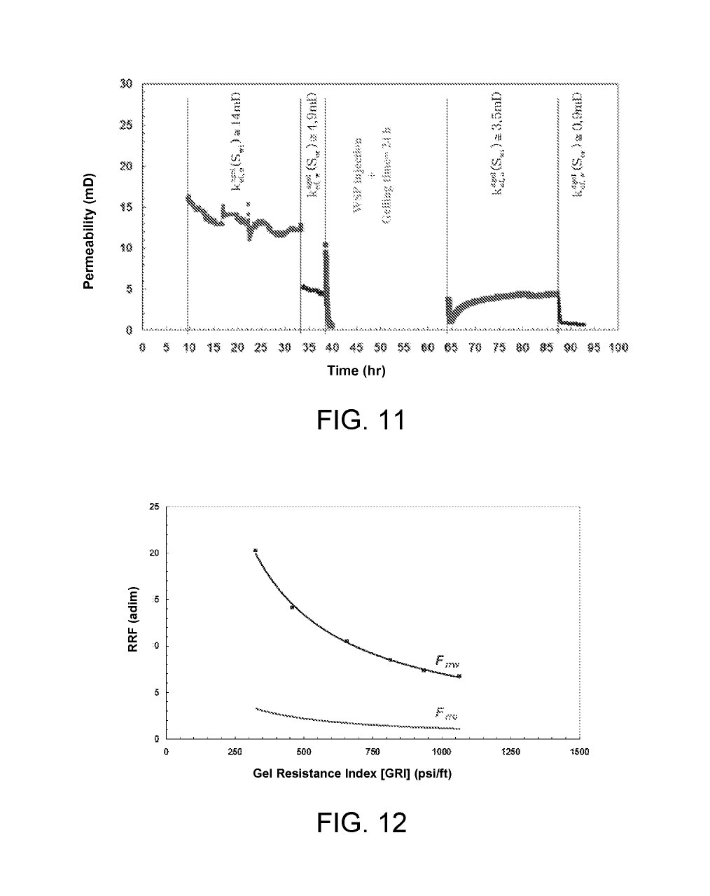

FIG. 11 shows the pumping sequence used in the test, where the permeability variation for each fluid as a function of time.

Table 2 summarizes the average permeability values, pre- and post-treatment, measured for water and hydrocarbon and their corresponding residual resistance factors RRF.

TABLE 2

| | Kₚᵣₑ (mD) | Kₚₒₛ (mD) | RRF |
|---|---|---|---|
| Gasoil | 14 | 3.5 | 4.0 |
| Water | 22 | 0.9 | 24.4 |

Test with Formation Sandstone Core Plug.

Taking into account that the formation sandstone core plug shows higher permeability and porosity than the Berea core plug previously tested, a sealant type WSO system was selected. This system shows good penetration, acquiring high rigidity once activated.

Table 3 summarizes average permeability values, pre- and post-treatment, measured for water and hydrocarbon and their corresponding residual resistance factors RRF.

TABLE 3

| | Kₚᵣₑ (mD) | Kₚₒₛ (mD) | RRF |
|---|---|---|---|
| Gasoil | 284 | 0.3 | 946 |
| Water | 65.6 | 0.006 | 10935 |

Polymer Bonding.

In order to evaluate the gel bonding degree to the formation a study was performed during the Berea sandstone core plug flow test. This study evaluates the maximum pressure gradient that the system can resist.

The differential pressure applied to the core plug during while pumping reference fluids (2-API brine and gasoil) was gradually increased, generating extreme flow conditions that could remove the treatment. Based on the data obtained in this test, one can verify in FIG. 12 the variation of RRF to oil and water as a function of pressure gradient applied, expressed in psi/ft. In this figure it can be observed that the present invention's WSO treatment is not swept from the test sample even when the pressure gradients arises 1000 psi/ft. The ratio between RRF and RRF_{O} is maintained in the same range (RRF_{W}/RRF_{O}≅6). A similar behavior was observed when testing the formation core plugs. In this case, the ratio RRF_{W}/RRF_{O} was kept between 10 and 11.5.

WSO Blocking Removal

As part of the study carried out using the formation core plug, once finished the test, a specific removal treatment based on oxidant agents was injected. This treatment results in an advantage of the present WSO system, since it permits recovering part of the original permeability of the treated formation core within the first 15 days of its placement.

The oxidative treatment was injected to the core plug (1.5 pore volume), leaving it to act during 2 hours. Afterwards, brine was injected at different flow rates in the production direction in order to determine the permeability recovery extent. After the injection of the removal system, the K_{W} average value increased by a factor of 6 related to the reference K_{Wpos} (from 0.006 to 0.036 mD). Therefore, RRF_{W} was reduced from 10935 to approximately 1820.

The present invention has shown that it is suitable for high temperatures. The crosslinking time can be managed by modification of polymer, crosslinker/modifier proportions obtaining gelation times from hours to days depending on where the WSO system must be placed into the formation.

In addition, the WSO system of the present invention suits to a wide range of service conditions, compositions, structures petrophysics of formations, temperatures, pressures, etc., that are found in the reservoirs.

An important difference of the present invention is the use of titanate as modifier that allows not only gelling times accelerations but also the desired final gel consistencies are obtained.

Other key difference that reinforces the uniqueness of the present invention is the introduction of a mechanism to turn the system reversible, with the possibility to remove the WSO upon use of specific oxidative agents.

While preferred embodiments of the present invention have been illustrated and described, it will be obvious to those skilled in the art that various changes and modifications may be made therein without departing from the scope of the invention as defined in the appended claims.

We claim:

1. A water shut-off system for producing at least a partial blockage in the water production of production and/or injection wells, the system comprising an aqueous composition including:
a) at least one polyacrylamide (PAM);
b) at least one crosslinker comprising an alkoxysilane compound, and
c) at least one modifier comprising an organotitanate.

2. The system of claim 1, wherein the at least one polyacrylamide (PAM) is a partially hydrolyzed polyacrylamide (HPAM) of 2 MDa<M_{W}<20MDa and the alkoxysilane compound is an alkoxysilane compound with at least two amine groups attached to an R substituent.

3. The system of claim 2, wherein the concentration of PAM in the aqueous composition is between about 0.3% w/v and about 4% w/v.

4. The system of claim 2, wherein the concentration of alkoxysilane compound is from about 0.03% w/v to about 3% w/v.

5. The system of claim 2, wherein the concentration of alkoxytitanate compound is from about 0.05% w/v to about 5% w/v.

6. The system of claim 2, including thiourea in a concentration of from about 0% w/v to about 0.2% w/v.

7. The system of claim 2, having an initial polymer composition viscosity which does not exceed 40 cp@ 300 rpm.

8. The system of claim 2, having a final viscosity which is not lower than 800 cp.

9. The system of claim 1, wherein the crosslinker is an organosilicon compound of the formula N-(β aminoR)-γ-aminoR₂trialkoxysilane, wherein R is alkyl or aryl groups and OX are the alkoxy groups:

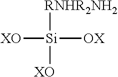

10. The system of claim 1, wherein the organotitanate compound is an acetylacetonate titanate chelate, lactic acid titanate chelate ammonium salt, triethanolamine titanate chelate or a mixture of chelates with at least one component that contains the following structure:

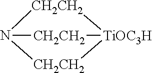

11. The system of claim 2, having a water shut-off macromolecule having a molecular weight between 2 MDa and 20 MDa.

12. The system of claim 11, wherein the macromolecule is polyacrylamide and/or polyacrylamide with a maximum hydrolysis degree of 50%.

13. The system of claim 1, wherein RRF_{W} values superior to 20 are obtained in formation core plugs.

14. The system of claim 1, wherein the WSO system supports high temperatures and its gelling time vary from hours up to days depending on the application.

15. The system of claim 1, wherein the WSO system can be injected in formations with variable petrophysical properties, porosity and permeability, assuring a suitable matrix penetration and elevated efficiency once the gel is formed.

16. The system of claim 1, wherein the WSO system is not swept from the formation even at pressure gradients higher than 1000 psi/ft.

17. The system of claim 1, wherein the WSO system can be partially removed upon use of oxidant agents in case of need to remove the blocking generated in the formation during the first 15 days of placement.

18. The system of claim 17, wherein the oxidant agents comprise persulphate or hypochlorite.

19. The system of claim 2, including KCl between about 0% w/v and about 2% w/v.

20. The system of claim 2, including water between about 86% w/v and about 99.7% w/v.

21. A method for preparing the Water Shut-off system according to claim 2, comprising the steps of:
Preparing a KCl brine;
Adding, under high agitation, the polymer to the brine previously prepared;
Agitating for approximately 2 hours or up to obtaining a constant viscosity and transparent appearance, with polyacrylamide granules totally hydrated,
Adding the titanate and following the crosslinker, and
Agitating until obtaining a total dispersion.
